(19) United States
(12) Patent Application Publication
(10) Pub. No.: US 2021/0298228 A1
(43) Pub. Date: Sep. 30, 2021

(54) TRANSPLANTER WITH SYNCHRONIZED PLANT DROP

(71) Applicant: Seed Research Equipment Solutions, LLC, South Hutchinson, KS (US)

(72) Inventor: Stacy L. Unruh, Haben, KS (US)

(73) Assignee: Seed Research Equipment Solutions, LLC

(21) Appl. No.: 17/216,306

(22) Filed: Mar. 29, 2021

Related U.S. Application Data
(60) Provisional application No. 63/000,638, filed on Mar. 27, 2020.

(51) Int. Cl. A01C 11/04; A01C 11/00

(52) U.S. Cl. CPC A01C 11/04; A01B 15/04; A01C 11/006

(57) ABSTRACT

An agricultural planter has a carousel-type distribution unit for handling and planting plants. The distribution unit has a rotatably driven carousel containing a plurality of cups adapted to hold plants. The cups are operable to release plants into a conveyance channel for guiding the plants into a hollow plowshare. An ejector foot expels the plants from the hollow plowshare into a soil furrow. A drive mechanism drives the distribution unit to rotate the carousel, release plants into the conveyance channel, and expel plants from the hollow plowshare. The drive mechanism in one embodiment includes a ratcheting arm connected to a drive shaft that drives the distribution unit, and a linear actuator connected to the ratcheting arm. A positioning system determines a location of the planter in a field, and a controller activates the linear actuator to rotate the ratcheting arm when the planter reaches a tripping position in the field.

### RELATED APPLICATIONS

This application claims the benefit of U.S. Provisional Patent Application No. 63/000,638 filed on Mar. 27, 2020. The entire content of such provisional application is incorporated herein by reference.

### TECHNICAL FIELD OF THE INVENTION

The present invention relates generally to agricultural machines, and in particular to planters and transplanters used for planting or transplanting seeds and plants in a grid-shaped pattern of rows.

### BACKGROUND ART

Machines for transplanting new plants in a field are known. For example, U.S. Pat. No. 6,394,010 issued to Pizzirani and assigned to Checchi & Magli S.r.l. of Budrio, Italy, discloses a “Carousel-Type Distribution Unit for Handling and Planting Vegetable Species.” In the transplanting machine disclosed in the '010 patent, plants are manually placed into a carousel by workers positioned on the planter, and the plants are released from the carousel into hollow plowshares and expelled at spaced intervals by ejector feet into furrows created by the plowshares. A mechanical drive system is provided by a ground engaging wheel that drives a chain connected to a sprocket for operating the carousel, the plant release mechanism, and the ejector feet as the machine moves through the field.

The plant spacing of the transplanting machine in the '010 patent can be adjusted by changing the sprockets of the chain drive system. However, the transplanting machine does not allow an operator to plant a field in a grid pattern with laterally aligned plant rows.

### SUMMARY OF THE INVENTION

### Technical Problem

There is a need in the industry for a transplanter that provides a synchronized drop of plants from multiple row units during multiple passes of the planter through the field to provide aligned rows of plants in both longitudinal and lateral directions relative to the direction of planting.

There is a further need for an agricultural planter with carousel-type distribution units that can be used with a positioning system to place plants at predetermined locations in a field.

There is a further need for an agricultural planter with an improved drive mechanism that uses a linear actuator and ratcheting arm to drive a carousel-type distribution unit instead of a chain drive assembly.

There is a further need for an improved agricultural planter that uses a GPS system to trigger when each seed or plant is placed into the ground, thereby ensuring that the seeds or plants will be in a uniform grid pattern across the field.

### Solution to Problem

An agricultural planter according to the present invention has a carousel-type distribution unit for handling and planting plants. The distribution unit has a rotatably driven carousel containing a plurality of cups adapted to hold plants. The cups are operable to release plants into a conveyance channel for guiding the plants into a hollow plowshare. An ejector foot is operable to expel the plants from the hollow plowshare into a soil furrow. A drive mechanism drives the distribution unit to rotate the carousel, release plants into the conveyance channel, and expel plants from the hollow plowshare. The drive mechanism according to one embodiment includes a ratcheting arm connected to a drive shaft that drives the distribution unit, and a linear actuator connected to the ratcheting arm. A positioning system determines a location of the planter in a field, and a controller activates the linear actuator to rotate the ratcheting arm when the planter reaches a tripping position in the field.

According to one aspect of the invention, an agricultural planter is provided, comprising: a carousel-type distribution unit for handling and planting plants, the distribution unit comprising a rotatably driven carousel containing a plurality of cups adapted to hold plants, the cups being operable to release the plants into at least one conveyance channel for guiding the plants into a hollow plowshare, and an ejector foot operable to expel the plants from the hollow plowshare into a soil furrow. A positioning system determines a location of the planter in a field. A drive mechanism drives the distribution unit to rotate the carousel, release plants into the conveyance channel, and expel plants from the hollow plowshare when the positioning system determines that the planter is at a predetermined tripping position in a field.

According to another aspect of the invention, an agricultural planter is provided, comprising: a carousel-type distribution unit for handling and planting plants, the distribution unit comprising a rotatably driven carousel containing a plurality of cups adapted to hold plants, the cups being operable to release the plants into at least one conveyance channel for guiding the plants into a hollow plowshare, and an ejector foot operable to expel the plants from the hollow plowshare into a soil furrow. A drive mechanism drives the distribution unit to rotate the carousel, release plants into the conveyance channel, and expel plants from the hollow plowshare. The drive mechanism has a ratcheting arm connected to a drive shaft that drives the distribution unit, and a linear actuator connected to the ratcheting arm.

According to another aspect of the invention, an agricultural planter is provided, comprising: a plurality of planting units for handling and planting plants in rows, the planting units each having a drive mechanism operable to release a plant into a soil furrow; a positioning system that determines a location of the planter in a field; and a controller that causes the drive mechanisms of each of the planting units to release a plant when the positioning system determines that the planter is at a predetermined tripping position in a field. As a result, plants from all of the planting units are released in a synchronized manner and aligned in a lateral direction relative to a direction of travel of the planter while planting.

Numerous other objects of the present invention will be apparent to those skilled in this art from the following description wherein there is shown and described embodiments of the present invention, simply by way of illustration of some of the modes best suited to carry out the invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the invention is made with reference to the accompanying drawings. In the drawings:

FIG. 1 is a perspective view of a transplanter being used to plant plants in a grid pattern in a field according to the present invention.

FIG. 2 is a side elevation view of the transplanter shown in FIG. 1, illustrating a GPS-controlled drive mechanism used to operate the planter carousel, release mechanism, and ejector foot for placing plants at selected locations in the field.

FIG. 3 is a diagram of a grid pattern of trigger points on a field that are used to trigger the GPS-controlled drive mechanism for placing plants in rows that are aligned both laterally and longitudinally.

FIG. 4 is a side elevation view of the transplanter according to the present invention.

FIG. 5 is a detail side view of the conventional chain drive mechanism used to drive the carousel, release mechanism and ejector feet of a transplanter implement.

FIG. 6 is a side view of the ratcheting drive mechanism used to drive the carousel, release mechanism and ejector feet of the transplanter according to the present invention.

FIG. 7 is an end view of the ratcheting drive mechanism shown in FIG. 6.

FIG. 8 is a side elevation view of the portion of the drive mechanism that drives the ejector feet in the transplanter implement.

FIG. 9 is a detail view of the ratcheting arm and actuator of the drive mechanism.

FIG. 10 is a cutaway view of the ratcheting arm and actuator shown in FIG. 9.

FIG. 11 is a cutaway view of the ratcheting arm being rotated in a counterclockwise direction with the pawl engaged to rotate the gear and driveshaft as the linear actuator is extended.

FIG. 12 is a cutaway view of the ratcheting arm being rotated in a clockwise direction with the pawl sliding over the gear teeth without rotating the gear and driveshaft as the linear actuator is contracted.

FIG. 13 is a side elevation view of a transplanter according to another embodiment of the present invention in which the GPS-controlled drive mechanism includes a stepper motor or servo motor to operate the planter carousel, release mechanism, and ejector foot for placing plants at selected locations in the field.

FIG. 14 is another side view of the drive mechanism shown in FIG. 13.

### DESCRIPTION OF EMBODIMENTS

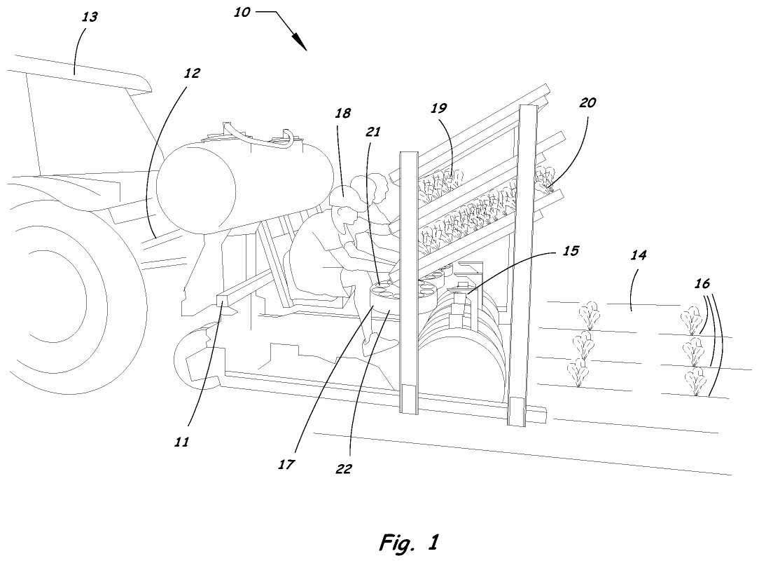

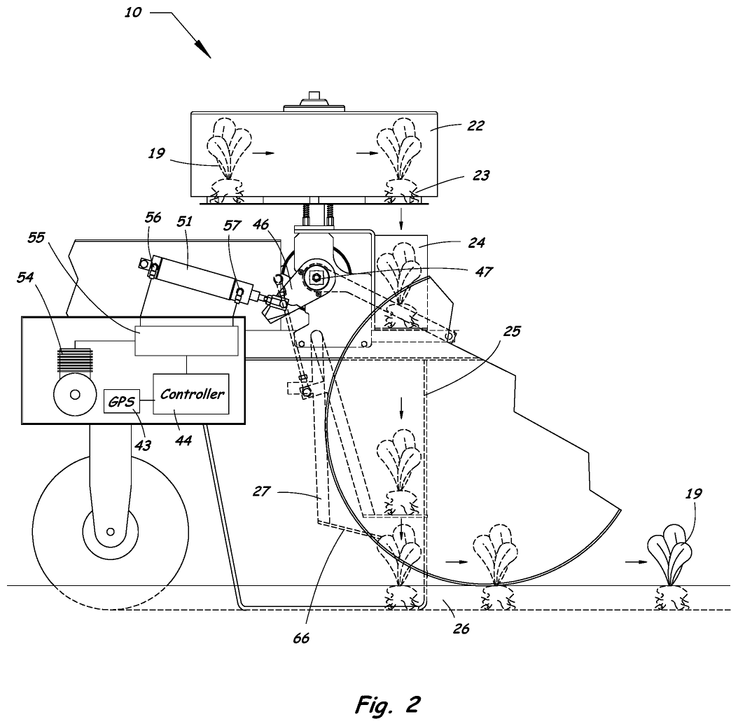

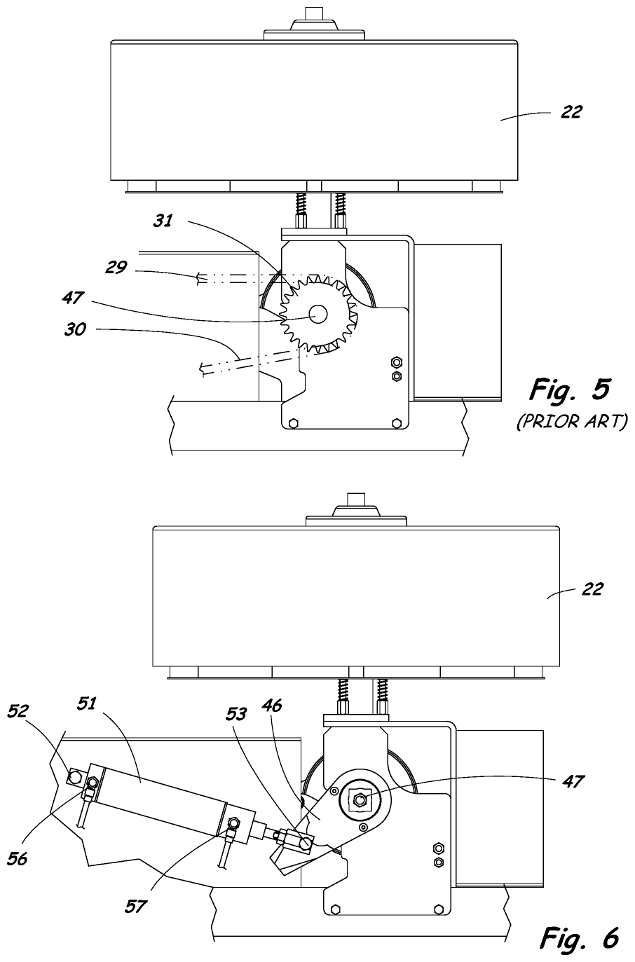

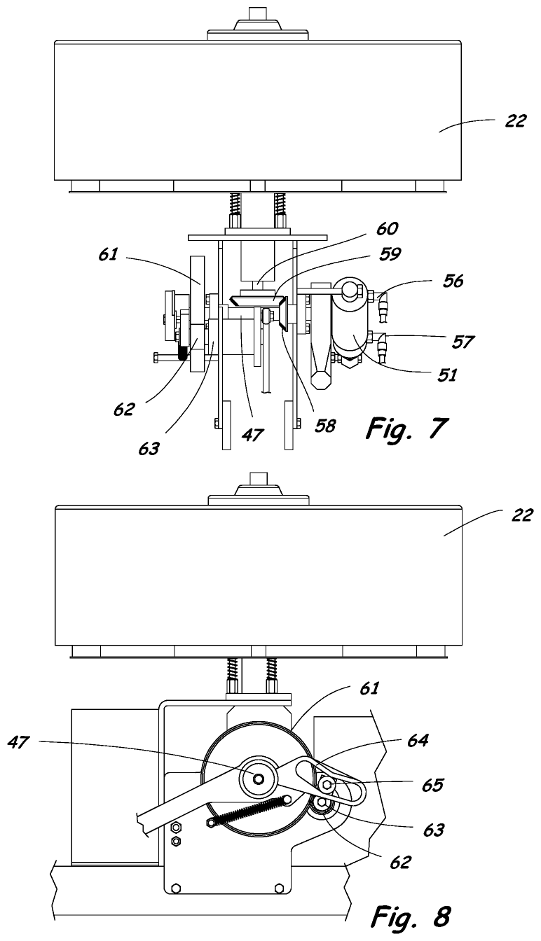

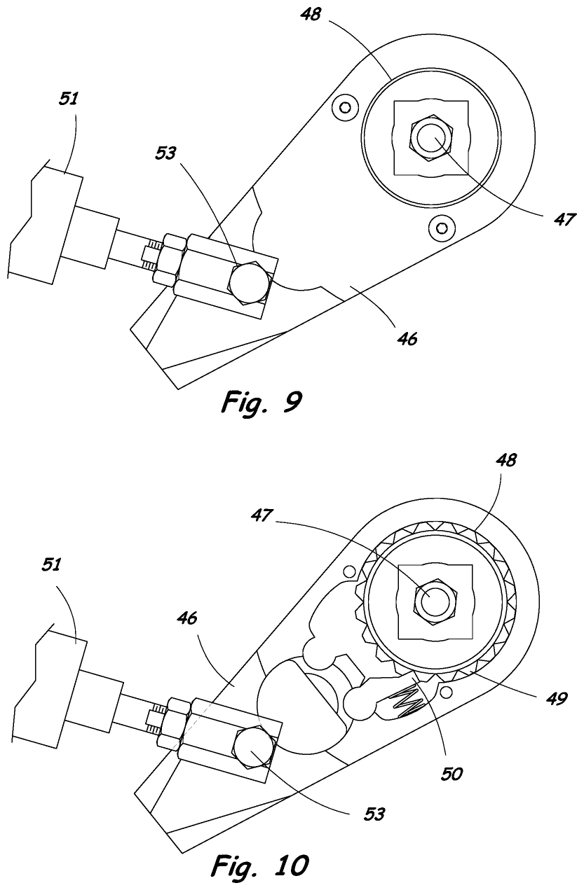

An agricultural planter 10 with a GPS-controlled drive mechanism according to the present invention will now be described with reference to FIGS. 1 to 14 of the accompanying drawings.

The agricultural planter 10 has a frame 11 adapted to be mounted to a hitch 12 on a tractor 13. As shown in FIG. 1, the planter 10 can be pulled by the tractor 13 through a field 14 to plant the field for food production, plant/seed research, or industrial plant production, such as hemp for industrial uses.

A plurality of row units 15 are provided across the width of the implement 10 for planting multiple rows 16 as the implement 10 traverses the field 14. Distribution units 17 are provided on the implement 10 to allow workers 18 positioned on the planter 10 to manually load plants 19 from trays 20 into cups 21 positioned along the circumference of carousels 22. The cups 21 include articulated elements 23 that are operated to drop the plants 19 contained therein into conveyance channels 24 located under the carousels 22. The conveyance channels 24 lead into respective hollow plowshares 25 that form furrows 26 in the soil. A plant ejector foot 27 is arranged and operated to gently eject the plants 19 rearwardly from the lower end 28 of the plowshares 25 into the furrows 26.

The carousel 22, release mechanism 23, plowshares 25, and ejector foot assembly 27 are used in conventional transplanter implements. For example, U.S. Pat. No. 6,394,010 issued to Pizzirani and assigned to Checchi & Magli S.r.l. of Budrio, Italy, discloses a conventional transplanter implement with such components, which may be used with the present invention. Additional details of these components are disclosed in U.S. Pat. No. 6,394,010, which is hereby incorporated by reference.

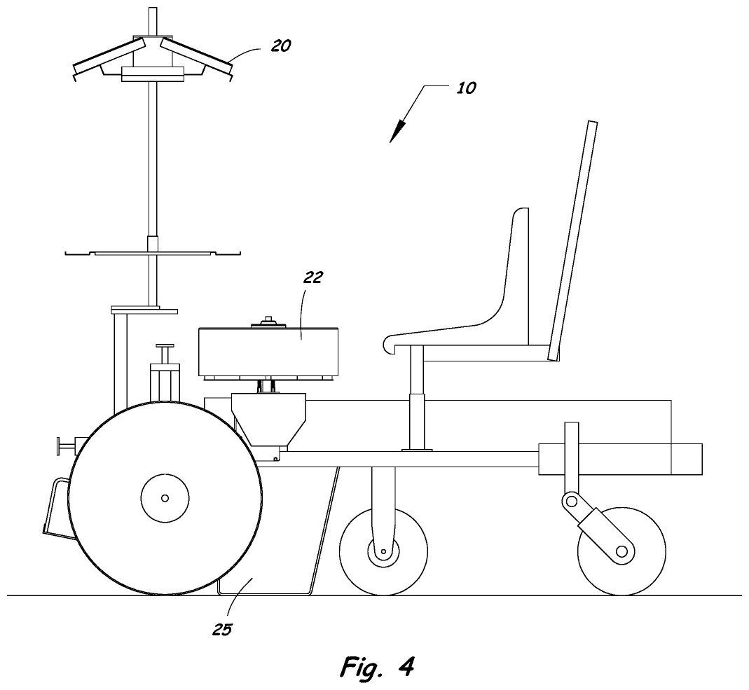

As illustrated in FIG. 5, the drive mechanism 29 of the conventional transplanter implement includes a drive chain 30 and sprocket assembly 31 that receives its driving force from a ground engaging wheel on the implement. The drive chain 30 and sprocket assembly 31 illustrated in FIG. 5 are not used in the present invention.

Instead, the present invention uses a linear actuator 40 and ratcheting arm assembly 41 as the drive mechanism 42 for driving the carousel 22, release mechanism 23, and ejector foot assembly 27. This allows the implement 10 to provide a controlled release point for each plant 19 based on a detected location of the implement 10 in the field 14. As a result, the implement 10 can be used to plant a field 14 with rows 16 that are aligned both longitudinally and laterally, as illustrated in FIG. 1.

The implement 10 includes a carousel-type distribution unit 17 for handling and planting the plants 19. The distribution unit 17 has one or more rotatably driven carousels 22 each containing a plurality of cups 21 adapted to hold plants 19. The cups 21 have articulated elements 23 that are operable to release the plants 19 into at least one conveyance channel 24 for guiding the plants 19 into the hollow plowshares 25. In one embodiment, the distribution unit 17 is arranged to release plants into conveyance channels and hollow plowshares situated on diametrically opposite sides of each carousel 22 so that one carousel 22 can be used to plant two rows. An ejector foot 27 is associated with each hollow plowshare 25 to expel the plants 19 rearwardly from the hollow plowshare 25 into the furrow 26 created by the plowshare 25.

A positioning system 43, such as a GPS device with a GPS receiver, is used to determine a precise location of the planter 10 in the field 14 based on GPS or other available position signals. A microprocessor controller 44 and computer program are used to control the planter functions based on the location of the planter 10 within the field 14. An output from the controller 44 is used to control the drive mechanism 42 that drives the distribution unit 17.

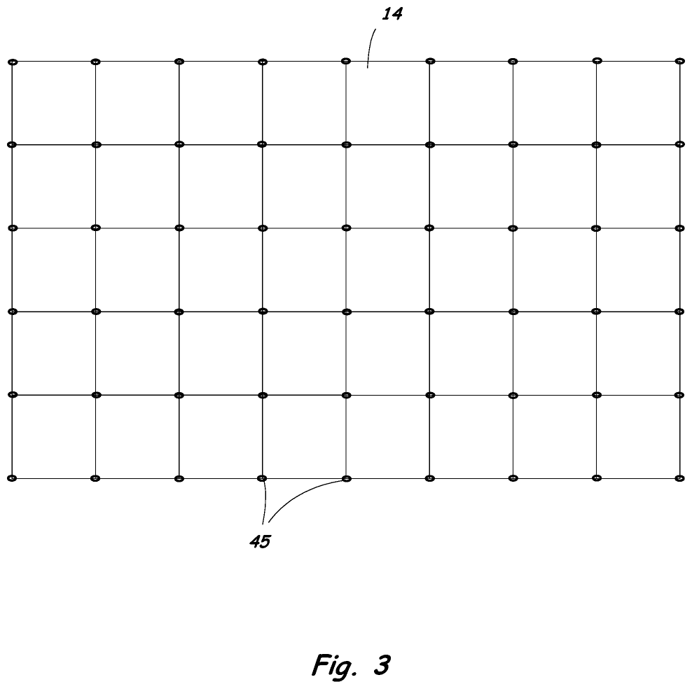

The present invention can be used with a field layout system that allows a user to create a desired field layout with a grid-shaped pattern of rows. As illustrated in FIG. 3, the field layout can include, among other things, a grid pattern of tripping points 45 at selected locations in the field 14, which are used by the controller 44 to determine when to activate the drive mechanism 42. The drive mechanisms 42 for multiple distribution units 17 across the width of the planter 10 can be activated at the same time by the controller 44 so that plants 19 are aligned in rows 16 in both a lateral direction and a longitudinal direction relative to the direction of planting.

The tripping points 45 created by the field layout system are spaced apart from each other the same distance as the desired spacing between the planted plants, and are provided for each pass of the planter 10 through the field 14. The field layout system can be programmed with various parameters, such as the set back distance from the GPS receiver to the point of plant release and adjustments to compensate for speed, so that precise lateral alignment of planted plants 19 can be achieved for multiple passes through the field 14 in either direction.

The drive mechanism 42 drives the distribution unit 17 to rotate the carousel 22, release plants into the conveyance channel 24, and expel plants from the hollow plowshare 25 when the positioning system 43 determines that the planter 10 is at a predetermined tripping position 45 in the field 14. The ejector foot 27 moves to expel one plant from the lower chamber of the hollow plowshare 25 rearwardly into the furrow 26 each time the distribution unit 17 is rotated a predetermined amount by the drive mechanism 42.

The drive mechanism 42 includes a ratcheting arm 46 connected to a drive shaft 47 that drives the distribution unit 17. The ratcheting arm 46 has a ratcheting mechanism 48 with a plurality of teeth 49 and a pawl 50 that engages the teeth 49. The ratcheting arm 46 operates to rotate the drive shaft 47 in a first direction in which the pawl 50 engages the teeth 49 to rotatably lock the ratcheting arm 46 and drive shaft 47 to rotate together. The ratcheting arm 46 is retracted in a second direction in which the pawl 50 slides over the teeth 49 to allow the ratcheting arm 46 to rotate back to its starting position without rotating the drive shaft 47, thereby resetting the drive mechanism 42.

A linear actuator 51 is provided to move the ratcheting arm 46. The linear actuator 51 has a first end 52 pivotally connected to a stationary point on the planter 10, and a second end 53 pivotally connected to a point on the ratcheting arm 46 spaced from the axis of the drive shaft 47. The linear actuator 51 in the illustrated embodiment is a two-way pneumatic cylinder that can be extended to cause the ratcheting arm 46 to rotate in a first direction, and that can be contracted to cause the ratcheting arm 46 to rotate in a second direction opposite the first direction. The ratcheting mechanism 48 in the ratcheting arm 46 causes the drive shaft 47 to rotate together with the ratcheting arm 46 in only one of the first and second directions.

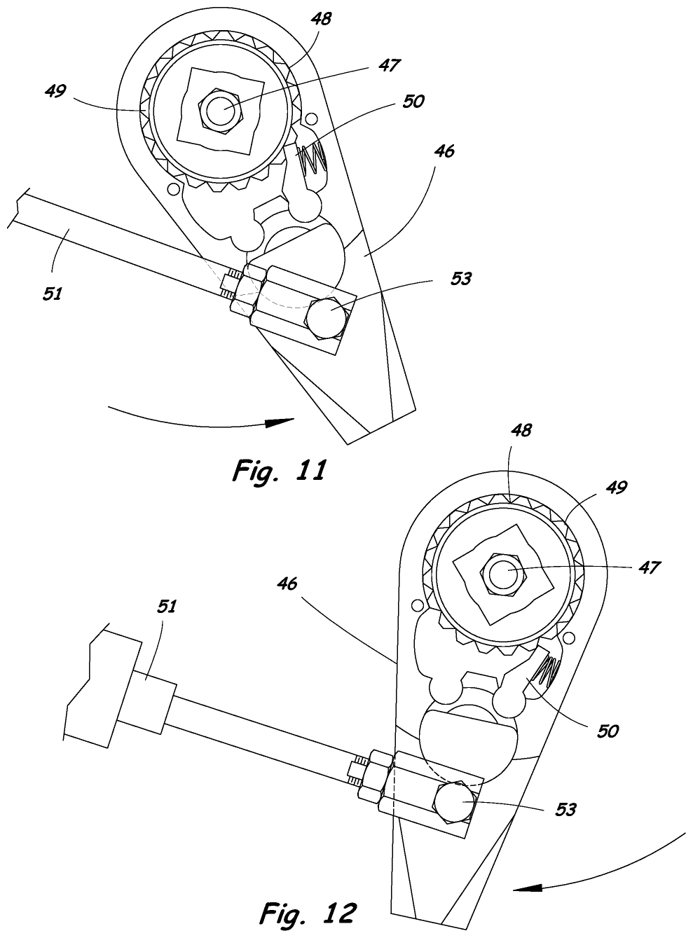

In the illustrated embodiment, the ratcheting mechanism 48 causes the drive shaft 47 to rotate in the counterclockwise direction upon extension of the linear actuator 51, as illustrated in FIG. 11. The ratcheting mechanism 48 allows the ratcheting arm 46 to be rotated clockwise to its starting position upon contraction of the linear actuator 51 without rotating the drive shaft 47, as illustrated in FIG. 12.

A compressor 54 is provided to supply pneumatic pressure to operate the linear actuator 51. A control valve assembly 55 is provided to control the flow of pneumatic pressure from the compressor 54 to the respective ports 56, 57 on the linear actuator 51. The control valve assembly 55 is operable to selectively extend and retract the linear actuator 51 in response to control signals from the controller 44.

Other sources of pressure can be used to operate the linear actuator 51 instead of pneumatic pressure supplied by an air compressor. For example, a hydraulic pressure source can be used to operate a linear hydraulic actuator to rotate the ratcheting arm 46.

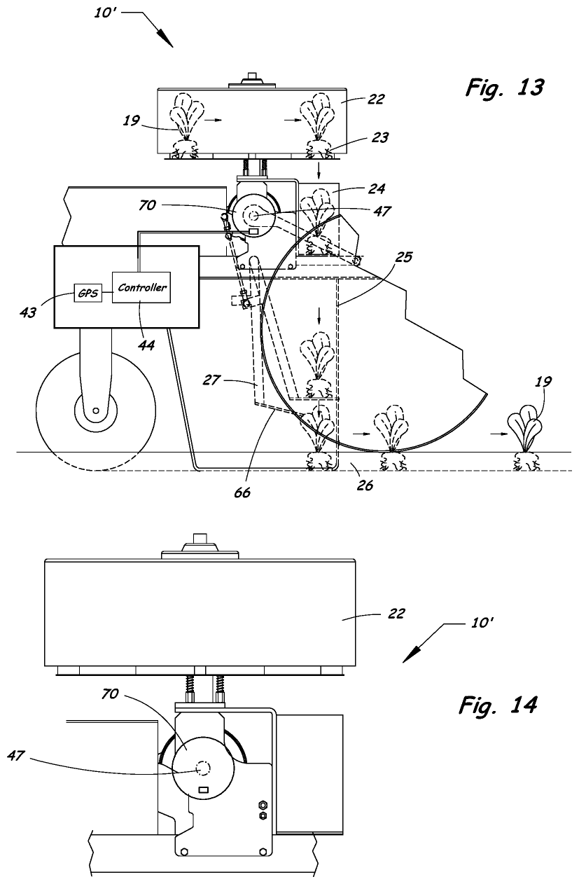

An agricultural planter 10′ having a GPS-controlled drive mechanism according to another embodiment of the invention is illustrated in FIGS. 13 and 14. In this embodiment, an electric drive motor 70, such as a stepper motor or servo motor, is used to drive the drive shaft 47, instead of the linear actuator 51 and ratcheting arm 46 used in the first embodiment described above. The electric drive motor 70 can be connected directly to the end of the drive shaft 47, or it can be connected to drive the drive shaft 47 via a sprocket and chain assembly or the like. The electric drive motor 70 will be selected to provide the necessary torque, speed and acceleration, as well as the desired accuracy in angular rotation to ensure that the drive mechanism will operate the distribution unit 17 with the desired speed and accuracy during planting operations.

The drive shaft 47 provides the driving force for a chain of mechanical components used to drive the distribution unit 17 to rotate the carousel 22, release plants into the conveyance channel 24, and expel plants from the hollow plowshare 25. The chain of mechanical components includes a first bevel gear 58 keyed to the drive shaft 47, which meshes with a second bevel gear 59 keyed to a vertical shaft 60 that supports the carousel 22. Rotation of the driveshaft 47 about its horizontal axis causes the carousel 22 to rotate with the vertical shaft 60 about its vertical axis. A conventional release mechanism 23 is provided within the carousel 22 to cause the articulated elements of the cups 21 to release the plants 19 contained in the cups 21 as the cups pass over their respective conveyance channels 24.

The chain of mechanical components also includes a large gear 61 keyed to the drive shaft 47 that meshes with a small gear 62 keyed to an auxiliary shaft 63. Rotation of the drive shaft 47 causes the auxiliary shaft 63 to rotate about its horizontal axis at a higher speed than the rotation of the drive shaft 47 due to a reduction ratio between the large gear 61 and the small gear 62. For example, by selecting the appropriate sizes for the gears 61, 62, a reduction ratio can be achieved so that rotation of the drive shaft 47 through a partial rotation angle of approximately 90 degrees will result in a full 360 degree rotation of the auxiliary shaft 63.

The ejector feet 27 are connected to the auxiliary shaft 63 via a linkage 64 and a crank 65 that make the ejector feet 27 move with a reciprocating curved motion. The lower ends 66 of the ejector feet 27 have a contoured shape adapted to gently expel the plants 19 from the lower chamber of the hollow plowshare 25. The ejector feet 27 are moved through one cycle to push out a plant 19 for each complete rotation of the auxiliary shaft 63. Further details of a suitable release mechanism, ejector feet, and chain of mechanical components for use in the present invention can be found, for example, in U.S. Pat. No. 6,394,010.

The aligned grid pattern of the planted plants in a field 14 provided by the present invention allows the field to be cultivated in both longitudinal and lateral directions relative to the direction traveled by the planter 10 when planting the field. This is particularly advantageous when planting crops, such as hemp, with a desired spacing between plants large enough (e.g., 24″ to 60″) to accommodate a vehicle tire and/or cultivator row unit to allow mechanical cultivation in multiple directions between adjacent plants in the planted rows.

The present invention has been described and illustrated as a transplanter. However, the same inventive concepts of a GPS-controlled release to provide a synchronized and simultaneous drop into laterally aligned rows can also be used with and applied to multi-row seed planters and other planters for placing plant material, such as cuttings, slips, tubers, clones or the like, into the soil. As used herein, the term “planter” is intended to cover all such planter types, and the terms “plant” or “plants” in the claims is intended to include seeds, plants and plant material.

While the invention has been described in connection with specific embodiments thereof, it is to be understood that this is by way of illustration and not of limitation, and the scope of the appended claims should be construed as broadly as the prior art will permit.

### INDUSTRIAL APPLICABILITY

The industrial applicability of the present invention is believed to be apparent from the description herein and the nature of the invention. The present invention can be used with agricultural planters, particularly those used to place plants and plant material into the soil.

What is claimed is:

1. An agricultural planter, comprising:
a carousel-type distribution unit for handling and planting plants, said distribution unit comprising a rotatably driven carousel containing a plurality of cups adapted to hold plants, said cups operable to release the plants into at least one conveyance channel for guiding the plants into a hollow plowshare, and an ejector foot operable to expel the plants from the hollow plowshare into a soil furrow;
a positioning system that determines a location of the planter in a field; and
a drive mechanism that drives said distribution unit to rotate the carousel, release plants into the conveyance channel, and expel plants from the hollow plowshare when said positioning system determines that the planter is at a predetermined tripping position in a field.

2. The agricultural planter according to claim 1, wherein said positioning system comprises a GPS receiver.

3. The agricultural planter according to claim 1, wherein said drive mechanism comprises a ratcheting arm connected to a drive shaft that drives said distribution unit, and a linear actuator connected to said ratcheting arm.

4. The agricultural planter according to claim 3, wherein said ratcheting arm is arranged to rotatably drive said drive shaft in a first direction as said linear actuator is moved in a first direction, and to rotate relative to said drive shaft in a second direction as said linear actuator is moved in a second direction.

5. The agricultural planter according to claim 3, wherein said ratcheting arm is arranged to rotatably drive said drive shaft in a first direction as said linear actuator is extended to cause said distribution unit to expel one plant into the soil furrow, and said ratcheting arm is arranged to rotate relative to said drive shaft in a second direction to reset the drive mechanism as said linear actuator is contracted.

6. The agricultural planter according to claim 3, wherein said linear actuator is a two-way pneumatic cylinder that can be extended to cause said ratcheting arm to rotate in a first direction of rotation, and that can be contracted to cause said ratcheting arm to rotate in a second direction of rotation opposite to said first direction, and wherein said ratcheting arm engages said drive shaft to rotate together with said ratcheting arm in only one of said first and second directions of rotation.

7. The agricultural planter according to claim 3, wherein said ratcheting arm has a ratcheting mechanism comprising a plurality of teeth and a pawl that engages the teeth, and wherein said ratcheting arm operates to rotate said drive shaft in a first direction in which the pawl engages the teeth to rotatably lock the ratcheting arm and drive shaft together, and wherein said ratcheting arm is retracted in a second direction in which the pawl slides over the teeth to allow the ratcheting arm to rotate back to a starting position.

8. The agricultural planter according to claim 1, wherein said drive mechanism comprises an electric stepper motor or servo motor connected to a drive shaft that drives said distribution unit.

9. An agricultural planter, comprising:
a carousel-type distribution unit for handling and planting plants, said distribution unit comprising a rotatably driven carousel containing a plurality of cups adapted to hold plants, said cups operable to release the plants into at least one conveyance channel for guiding the plants into a hollow plowshare, and an ejector foot operable to expel the plants from the hollow plowshare into a soil furrow; and
a drive mechanism that drives said distribution unit to rotate the carousel, release plants into the conveyance channel, and expel plants from the hollow plowshare, said drive mechanism comprising a ratcheting arm connected to a drive shaft that drives said distribution unit, and a linear actuator connected to said ratcheting arm.

10. The agricultural planter according to claim 9, further comprising a positioning system that determines a location of the planter in a field, and a controller that activates said drive mechanism when said positioning system determines that the planter is at a predetermined tripping position in the field.

11. The agricultural planter according to claim 9, wherein said positioning system comprises a GPS receiver.

12. The agricultural planter according to claim 9, further comprising a positioning system that determines a location of the planter in a field; and
a controller that causes the drive mechanism to drive said distribution unit to rotate the carousel, release a plant into the conveyance channel, and expel a plant from the hollow plowshare when said positioning system determines that the planter is at a predetermined tripping position in a field.

13. The agricultural planter according to claim 9, wherein said ratcheting arm is arranged to rotatably drive said drive shaft in a first direction as said linear actuator is extended to cause said distribution unit to expel one plant into the soil furrow.

14. The agricultural planter according to claim 13, wherein said ratcheting arm is arranged to rotate relative to said drive shaft in a second direction to reset the drive mechanism as said linear actuator is contracted.

15. The agricultural planter according to claim 9, wherein said ratcheting arm has a ratcheting mechanism comprising a plurality of teeth and a pawl that engages the teeth, and wherein said ratcheting arm operates to rotate said drive shaft in a first direction in which the pawl engages the teeth to rotatably lock the ratcheting arm and drive shaft together, and wherein said ratcheting arm is retracted in a second direction in which the pawl slides over the teeth to allow the ratcheting arm to rotate back to a starting position.

16. An agricultural planter, comprising:
a plurality of planting units for handling and planting plants in rows, said planting units each having a drive mechanism operable to release a plant into a soil furrow;
a positioning system that determines a location of the planter in a field; and
a controller that causes the drive mechanisms of each of the planting units to release a plant when said positioning system determines that the planter is at a predetermined tripping position in a field, whereby plants from all of the planting units are released in a synchronized manner and aligned in a lateral direction relative to a direction of travel of the planter while planting.

17. The agricultural planter according to claim 16, wherein said planting units comprise carousel-type distribution units for handling and planting plants, said distribution units each comprising a rotatably driven carousel containing a plurality of cups adapted to hold plants, said cups being operable to release the plants into at least one conveyance channel for guiding the plants into a hollow plowshare, and an ejector foot operable to expel the plants from the hollow plowshare into the soil furrow.

18. The agricultural planter according to claim 16, wherein said drive mechanisms comprise ratcheting arms connected to drive shafts that drive said carousel-type distribution units, and linear actuators connected to said ratcheting arms.

19. The agricultural planter according to claim 18, wherein said ratcheting arms each have a ratcheting mechanism comprising a plurality of teeth and a pawl that engages the teeth, and wherein said ratcheting arms operate to rotate said drive shafts in a first direction in which the pawls engage the teeth to rotatably lock the ratcheting arms and drive shafts together, and wherein said ratcheting arms are retracted in a second direction in which the pawls slide over the teeth to allow the ratcheting arms to rotate back to a starting position.

20. The agricultural planter according to claim 16, wherein said drive mechanisms each comprises an electric stepper motor or servo motor connected to a drive shaft that drives said distribution unit.

21. The agricultural planter according to claim 16, wherein said positioning system comprises a GPS receiver.
